(19) United States
(12) Patent Application Publication
(10) Pub. No.: US 2007/0250807 A1
(43) Pub. Date: Oct. 25, 2007

(54) METHOD, SYSTEM AND MEMORY FOR REPLACING A MODULE

(75) Inventor: M. George GEORGE, Madhapur (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/534,929

(22) Filed: Sep. 25, 2006

Related U.S. Application Data
(63) Continuation-in-part of application No. 10/753,072, filed on Jan. 8, 2004, now abandoned.

(51) Int. Cl. G06F 9/44

(52) U.S. Cl. 717/100

(57) ABSTRACT

An implementation module is replaced without affecting system continuity by creating, within an interface module, a plurality of proxy functions corresponding to a plurality of proxy functions within the implementation module. Entries into and exits out of the implementation module are tracked by the system. When the implementation module is to be replaced, the interface module blocks entry by the system into the implementation module. When the number of entries corresponds to the number of exits, the implementation module is replaced. Static and global variables of the implementation module are defined in the interface module.

### RELATED APPLICATIONS

This application is a continuation in part (CIP) of U.S. application Ser. No. 10/753,072, filed Jan. 8, 2004, which is incorporated by reference herein in its entirety.

### TECHNICAL FIELD

The disclosure relates to a method, system and memory for replacing a module, and more particularly, but not exclusively, to a method, system and software for online replacement of an implementation module without affecting application or system continuity.

### BACKGROUND

Software components for applications and operating systems often require updating or “patching” after they have been deployed.

Some applications and operating systems are mission-critical. This means that they must be available, or online, for use at all times. In such cases it can be difficult to replace the software components when it becomes necessary.

One major difficulty with “online” replacement of software components is that state information—global and static variables—within the component needs to be preserved when the component is replaced by a new component if application/system continuity is desired.

Prior solutions to preserve state information during module replacement require either (1) saving and restoring state; or (2) compiler support. The former is error prone as significant programming is required to save and restore each variable. The latter is also error prone as adding a variable in the module can result in state information becoming stale. With prior solutions module state has to be reset or saved, and restored to replace the module or use special memory management to preserve state which makes the solution not portable across different operating systems. This will impact application availability as state information becomes unavailable during this operation. Additional support is required when modules for multi-threaded applications/systems are replaced to ensure that all threads of the application/system do not call the module being replaced.

The following patents cover methods for updating software components:

U.S. Pat. No. 6,154,878 and U.S. Pat. No. 6,336,215 which are incorporated by reference herein in their entirety.

The disadvantages of U.S. Pat. No. 6,154,878 are:
a. The method is only applicable to a shared library and does support all software modules such as kernel modules.
b. State information is permitted to be kept in the implementation module which requires either:
   a. saving and restoring of state information which makes the solution complex and error prone as knowledge of each data item to be restored is required. In particular, the patent requires saving each variable before the module is unloaded and restoring state of each variable after the new module is loaded. Thus, if even one variable is not saved or restored, the state will not be restored after module replacement which can lead to unpredictable results; or
   b. compiler support to preserve state information across unloading and loading of new module. This imposes the severe restriction that no change of the data definition of the older module is allowed in addition to requiring modification to the loader to preserve data across unload and load.

In accordance with U.S. Pat. No. 6,336,215, if addresses of data structures in the new module are different compared to the replaced module, linker support is required to replace only code which limits usage of this solution for systems which have linkers that retain the same addresses across unloads and loads. Major changes will be required for linkers that load kernel modules to satisfy this requirement. The data segment address space may have to be split to meet this requirement. Another drawback of this approach is that all the code is replaced and hence none of the threads can be active during replacement. The third drawback is that the whole process may require significant amount of code changes. Therefore, it is expensive to build and maintain. The fourth drawback is that it is applicable only for user space processes and not for kernel modules.

There is a need to overcome one or more of the disadvantages of the prior art, or to at least provide the public with a useful choice.

### SUMMARY

According to an aspect, there is provided a method of replacing an implementation module used by a system, including the steps of:
i) creating an interface module;
ii) creating a plurality of proxy functions within the interface module corresponding to a plurality of functions within the implementation module;
iii) tracking entries into and exits out of the implementation module by the system;
iv) when the implementation module is to be replaced:
   a. the interface module blocking entry by the system into the implementation module; and
   b. when the number of entries correspond to the number of exits, replacing the implementation module;
wherein the system uses the functions within the implementation module by calling the proxy functions and wherein static and global variables of the implementation module are defined within the interface module.

According to a further aspect, there is provided a method of converting an implementation module, comprised of a plurality of functions, to a replaceable implementation module, comprising the steps of:
i) creating an interface module;
ii) creating a plurality of proxy functions, corresponding to the implementation functions, within the interface module; and
iii) defining global and static variables of the implementation module in the interface module rather than in the implementation module.

According to a further aspect, there is provided an interface module for an implementation module, comprising:
i) a plurality of proxy functions corresponding to a plurality of functions within the implementation module;
ii) a tracking mechanism which records the number of implementation functions in use;
iii) a blocking mechanism which blocks calls to the implementation functions when the module is to be replaced;
iv) a replacement mechanism which replaces the implementation module when no implementation functions are in use; and
v) all global and static variables extracted from the implementation module.

According to a further aspect, there is provided a system for replacing an implementation module, comprising:
i) a memory which stores an implementation module comprised of a plurality of functions;
ii) a memory which stores an interface module comprised of all global and static variables extracted from the implementation module and a plurality of proxy functions corresponding to the implementation functions; and
iii) a processor arranged for relaying calls to use an implementation function to a corresponding proxy function, tracking the use of the implementation functions, blocking calls to the implementation functions when the implementation module is to be replaced, and replacing the implementation module when no implementation functions are in use.

A further aspect relates to a method of and system for replacing an implementation module. The method is performed with the aid of an interface module that is included in the system.

An additional aspect relates to a method of and system for converting an implementation module, comprised of a plurality of functions, to a replaceable implementation module, the method being performed with the aid of an interface module that is included in the system.

Additional aspects and advantages of the disclosed embodiments are set forth in part in the description which follows, and in part are obvious from the description, or may be learned by practice of the disclosed embodiments. The aspects and advantages of the disclosed embodiments may also be realized and attained by the means of the instrumentalities and combinations particularly pointed out in the appended claims.

### BRIEF DESCRIPTION OF THE DRAWINGS

Embodiments of the invention will now be described, by way of example only, with reference to the accompanying drawings in which elements having the same reference numeral designations represent like elements throughout and in which:

FIG. 1: is a diagram of how the method in accordance with an embodiment enables use of an implementation module through an interface module.

FIG. 2: is a diagram of how the method blocks further calls to use functions within the implementation module when module replacement is to occur.

FIG. 3: is a diagram of how the method replaces the module.

FIG. 4: is a diagram illustrating how the method converts an implementation module into a replaceable implementation module.

FIGS. 5-7: are diagrams illustrating how the method in accordance with further embodiments converts an implementation module into a replaceable implementation module.

### DETAILED DESCRIPTION OF EMBODIMENTS

In the following detailed description, for purposes of explanation, numerous specific details are set forth in order to provide a thorough understanding of the embodiments. It will be apparent, however, that the embodiments may be practiced without these specific details. In other instances, well-known structures and devices are schematically shown in order to simplify the drawing.

In a preferred embodiment a module replacement can be done without the requirement to restore state and ensuring application/system continuity. Applications and systems can continue the operations they were performing as soon as the module is replaced.

In a preferred embodiment all the module state information in an interface module and the heap is retained. Only temporary module state information in the stack or temporary module state that is valid only when the implementation module is active (active corresponding a state where an implementation module function is called by any thread and call has not returned) is defined in the implementation module. All remaining state information is defined in global variables in the interface module and the heap. Since there is no state in the implementation module when the implementation module is not active, there is no need to restore state when the implementation module is replaced.

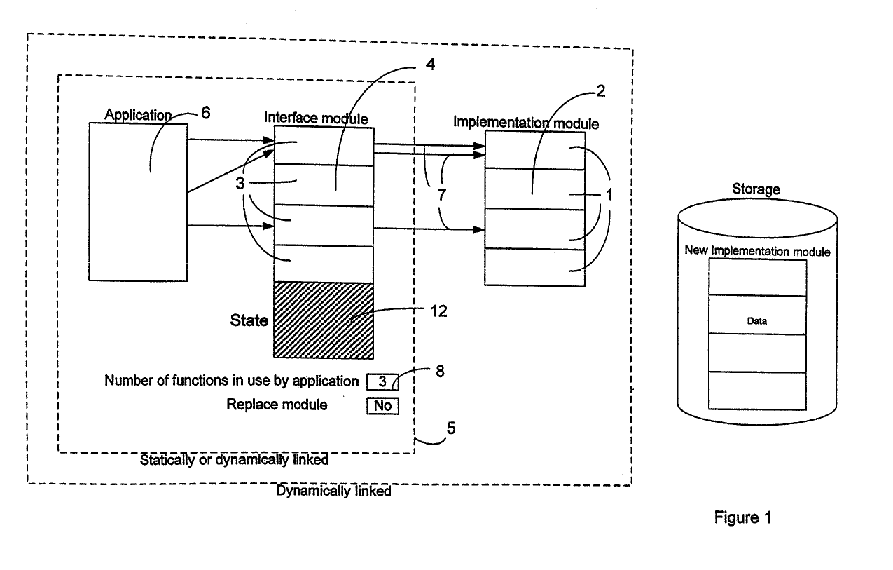

A method of and apparatus for preserving application availability during module replacement is now described with reference to FIGS. 1 to 3.

It will be appreciated that method can be used to ensure operating system availability, during OS module replacement, with appropriate modifications.

The first step is that all entry functions 1 of the module 2 that can be replaced should be accessed through stubs 3 (proxy functions) in interface module 4 as explained in U.S. Pat. No. 6,154,878. The interface module 4 may be statically or dynamically linked 5 to the application 6.

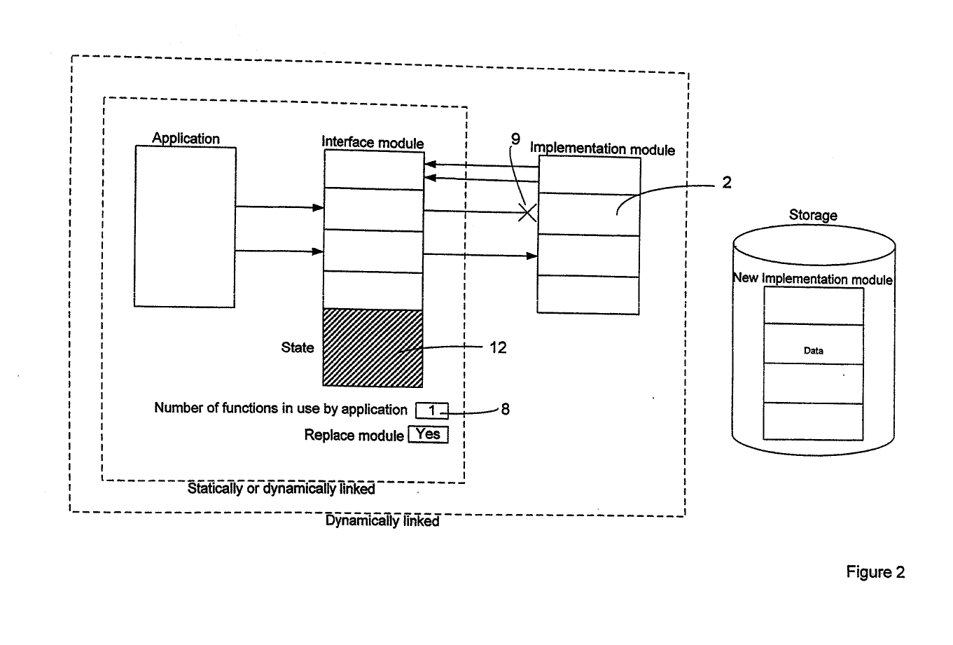

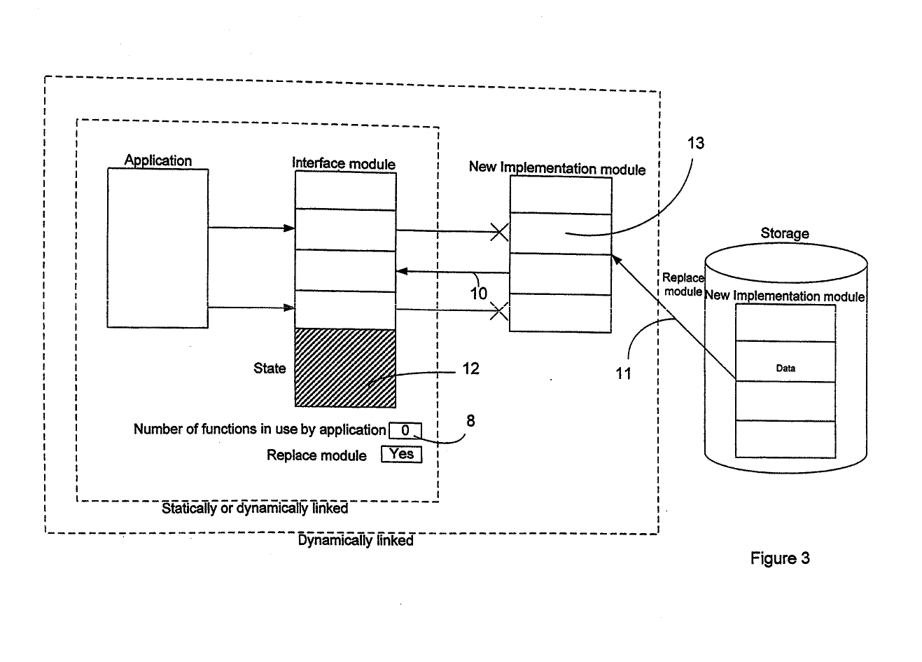

The second step is that all entries 7 into or out of the implementation module 2 are tracked using reference counts 8 and/or other tracking mechanisms, such as reference flags. The interface module 4 will block calls 9 (see FIG. 2) into implementation module 2 when it is safe to do so and, after all previous calls to implementation module return 10 (see FIG. 3), replace the module 11.

In the third step module state 12 has been preserved in the interface module and in the heap. Therefore the module state is preserved across replacement and the application 6 can continue accessing the module 13 after replacement and continue execution.

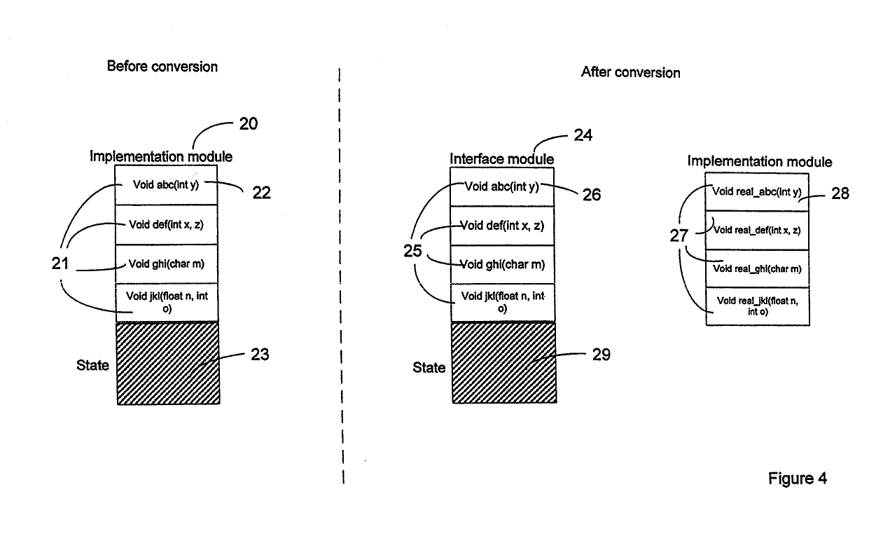

An example, which illustrates how the implementation is converted into a replaceable implementation module, will now be described with reference to FIG. 4. In this example, the number of calls to the replaceable module is tracked using a reference counter.

The example considers a module “X.c” 20. The module X.c is such that its functions do not call functions in another module. The module “X.c” 20 is made of functions 21 in a “C language file” “X.c”. Consider a function “void abc(int y)” 22 which is part of the module “X.c” 20. In order to replace module “X.c” preserving state information 23, the following steps are performed:
1. Create an interface module 24, “Interface_X.c”, which may be statically or dynamically linked.
2. For each function 21 in module “X.c”, create an interface (stub) function 25 with same name and parameters in “Interface_X.c”. So function “void abc(int y)” 26 is added into “Interface_X.c” 24.
3. Rename the functions 27 in module “X.c”. “Void abc(int y)” is renamed to “void real_abc(int y)” 28. Since the function is renamed, all calls to function “void abc(int y)” will now go to the interface function “void abc(int y)” 26 in “Interface_X.c” 24.
4. Move all variables that hold state information in “X.c” into “Interface_X.c” 29.
5. Number of function calls to “X.c” is tracked within the pseudo-code below using variable “X_reference count”. Pseudo-code, similar to that for interface function “void abc(int y)” shown below, should be added for each interface function in “Interface_X.c” so that “X_reference_count” gives the number of active calls to module “X.c” (that are currently active). Module “X.c” can be replaced when the value of “X_reference_count” is zero.

Pseudo-code for the stub function “void abc(int y)” within the interface module is given below:

File “Interface_X.c”::
/* ALL VARIABLES FROM X.c HOLDING STATE INFORMATION
ARE DEFINED */
...
/* ALL VARIABLES FROM X.c DEFINED ABOVE */
char X_replace_module_flag = 0; /* THE FLAG IS SET WHEN
MODULE NEEDS TO BE
REPLACED */
long X_reference_count=0; /* GIVES THE NUMBER OF CALLS
CURRENTLY MADE INTO
MODULE “X.c” THAT HAVE NOT RETURNED */
void (*real_abc)(int y);
void abc(int y)
{

do {

lock( );
if (X_replace_module_flag IS SET) {

/*
* REPLACE “X.c” IF POSSIBLE
*/
if (X_reference_count > 0) {

/*
* THERE ARE ACTIVE CALLS TO
FUNCTIONS IN “X.c”
* GO TO SLEEP
*/
unlock( );
sleep for “Z” milli/microseconds;
continue; // REPEAT THE do LOOP

}
else {

/*
* THERE ARE NO ACTIVE
CALLS TO X.c
* SO REPLACE X.c
*/
unload module “X.c”;
load new version of module “X.c”;
/*
Update pointers to real functions;
*/
real_abc =
GET-NEW-POINTER(new_module_handle,
“real_abc”);
X_replace_module_flag = 0; /*
INDICATE THAT MODULE
REPLACEMENT IS COMPLETE */
unlock( );
continue; // REPEAT THE do LOOP

}

}
else {

/* INDICATE THAT A FUNCTION IN X.c IS
CALLED ONCE MORE */
X_reference_count++;
unlock( );
break; // COME OUT OF THE LOOP

}

}
real_abc(y);/* THE ACTUAL FUNCTION IN “X.c”
IS CALLED HERE */
lock( );
/* INDICATE THAT A CALL TO A FUNCTION IN X.c
HAS RETURNED */
X_reference_count−−;
if ((X_replace_module_flag IS SET) AND
(X_reference_count IS 0) {

/*
* REPLACE X.c
*/
unload module X;
load new version of X;
X_replace_module_flag = 0; /* INDICATE THAT
MODULE REPLACEMENT IS
COMPLETE*/

}
unlock( );

}

6. The pseudo-code given in step (5) for interface functions is effective as long as the corresponding functions in “X.c” do not sleep or wait for events indefinitely. If the functions go to sleep or wait indefinitely, module specific code is needed to ensure the functions are woken up or the wait is broken. Alternatively, “X.c” could be rewritten to move sleep/wait out of “X.c”. Such changes are module specific and are outside the scope of this invention.

The steps can be performed by a programmer utilizing standard programming processes, or they could be performed automatically using a script.

Further embodiments of the present invention are also provided in which global variables are redefined in addition to or instead of the function renaming approach described above.

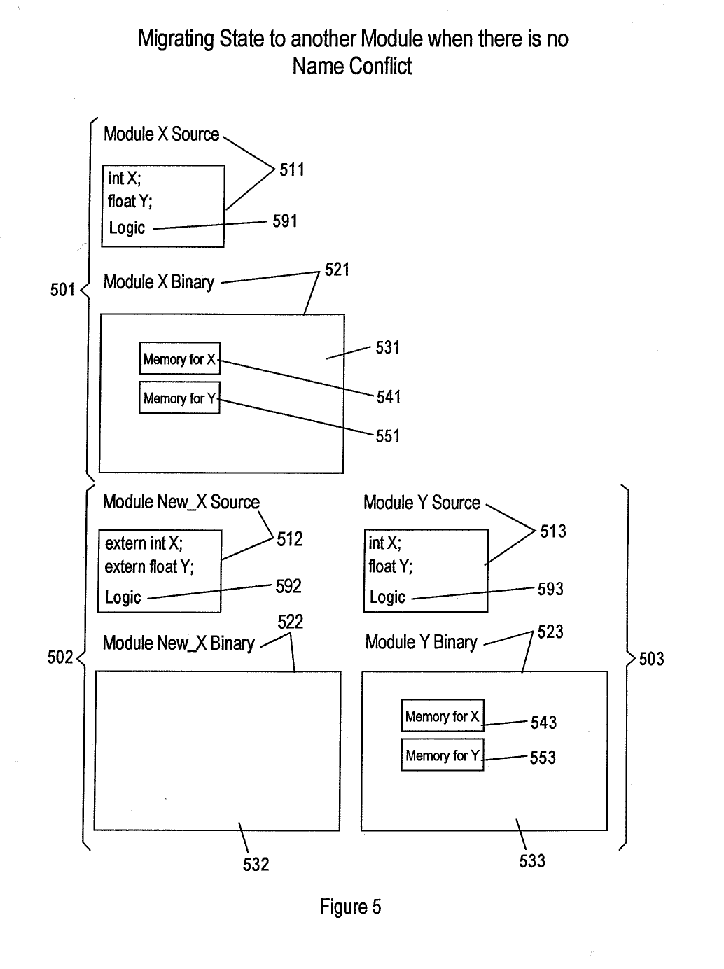

Specifically, FIG. 5 is a diagram illustrating how the method in accordance with a further embodiment converts an implementation module 501 into a replaceable implementation module 502 by using an interface module 503. This embodiment addresses the specific situation where there is no name conflict.

Implementation module 501 can be presented as a Module X Source 511 in a programming language, e.g., C or C++, or as a Module X Binary 521 in computer-executable format. Other programming languages are not excluded and can be used with further embodiments of the present invention. When Module X Source 511 is complied by a complier (not shown), Module X Binary 521 will be outputted by the compiler, and can be subsequently linked and loaded in the memory of a computer system running implementation module 501. FIG. 5 shows the allocation 531 of memory storage for use by Module X Binary 521 during the runtime of implementation module 501.

Likewise, replaceable implementation module 502 can be presented as a Module New_X Source 512 in a programming language, e.g., C or C++, or as a Module New_X Binary 522 in computer-executable format. When Module New_X Source 512 is complied by a complier (not shown), Module New_X Binary 522 will be outputted by the compiler, and can be linked and loaded in the memory of the computer system running replaceable implementation module 502. FIG. 5 shows the allocation 532 of memory storage for use by Module New_X Binary 522 during the runtime of replaceable implementation module 502.

Similarly, interface module 503 can be presented as a Module Y Source 513 in a programming language, e.g., C or C++, or as a Module Y Binary 523 in computer-executable format. When Module Y Source 513 is complied by a complier (not shown), Module Y Binary 523 will be outputted by the compiler, and can be linked and loaded in the memory of the computer system running interface module 503. FIG. 5 shows the allocation 533 of memory storage for use by Module Y Binary 523 during the runtime of interface module 503.

Module X Source 511 has global variables, such as X and Y, which define the state information of implementation module 501. In this particular example, X is declared or globally defined in implementation module 501 as an integer and Y as a floating point number. However, the invention is not limited to this example. Global variables X and Y are assigned/stored at memory addresses Memory for X 541 and Memory for Y 551, respectively, in the memory allocation 531 of Module X Binary 521. In accordance with the disclosed embodiments of the present invention, the state information is moved out of the implementation module when the implementation module is to be replaced or converted to a replaceable implementation module. This can be done in the following manner.

Module New_X Source 512, which is a source code file, is generated based on Module X Source 511 which is also a source code file, by redefining the global variables, e.g., X and Y, of Module X Source 511. In this particular example, the source code files Module X Source 511 and Module New_X Source 512 use C or C++ programming language, and hence, global variables X and Y are redefined using the “extern” declaration (meaning that X and Y are defined external to Module New_X Source 512). However, other programming languages and, hence, other declarations can be used without escaping from the spirit and scope of the present invention. The redefinition of the global variables can be performed, in accordance with an aspect of the present invention, by using Find and Replace commands of a text editor, such as Word Pad or Word Perfect or the like. The remainder of Module X Source 511, which does not include the global variables, is generally referred to herein below as “logic” 591 and is preferably moved entirely without changes (exceptions will be described herein below) to Module New_X Source 512, as logic 592. Logic 592 may further include necessary code instructions to handle calls from interface module 503. As can be seen in FIG. 5 at 532, when Module New_X Source 512 is complied by a complier and loaded, the memory allocation 532 for the resulting Module New_X Binary 522 does not include memory addresses for X and Y. The so-created implementation module 502, in form of Module New_X Source 512 and/or Module New_X Binary 522, is a “stateless” implementation module, because it does not include any global variables or state information of implementation module 501, and is therefore replaceable.

Module Y Source 513, which is a source code file, is generated by adding the definitions of global variables X and Y to logic 593. Logic 593 handles, among other things, calls to and from applications and/or replaceable implementation module 502 as well as call blocking and entry tracking during module replacement as disclosed above with respect to FIGS. 1-4. In this particular embodiment, the global variable definitions of X and Y, i.e., “int X” and “float Y” are simply copied, by using, e.g., a text editor, from Module X Source 511, which is a source code fie, to Module Y Source 513. As a result, when Module Y Source 513 is complied by a complier and loaded, the memory allocation 533 for the resulting Module Y Binary 523 will include memory addresses 543, 553 for X and Y, respectively. Thus, in can be said that the global variables, i.e., X and Y, of implementation module 501 have been moved to interface module 503 which now contains the state information whereas replaceable implementation module 502 does not.

The above description can be illustrated in the following example:

### EXAMPLE 1

Redefine every global variable in the implementation module to be replaced as extern, and define the same variable in the interface module.
Original implementation module 501 contains the following definitions:
   int X;
   float Y;
Implementation module 501 is modified as follows to create stateless or replaceable implementation module 502:
   extern int X;
   extern float Y;
The original definitions of global variables X and Y are added into interface module 503:
   int X;
   float Y;

In the above described embodiment, since all changes are to be made to the source code files, i.e., Module X Source 511, Module New_X Source 512 and Module Y Source 513, which are human-readable and understandable, without having to actually save and restore state information, the module replacement process is much simpler and less error-prone. In addition, the described embodiment is applicable to both user space libraries and kernel modules, unlike the prior art.

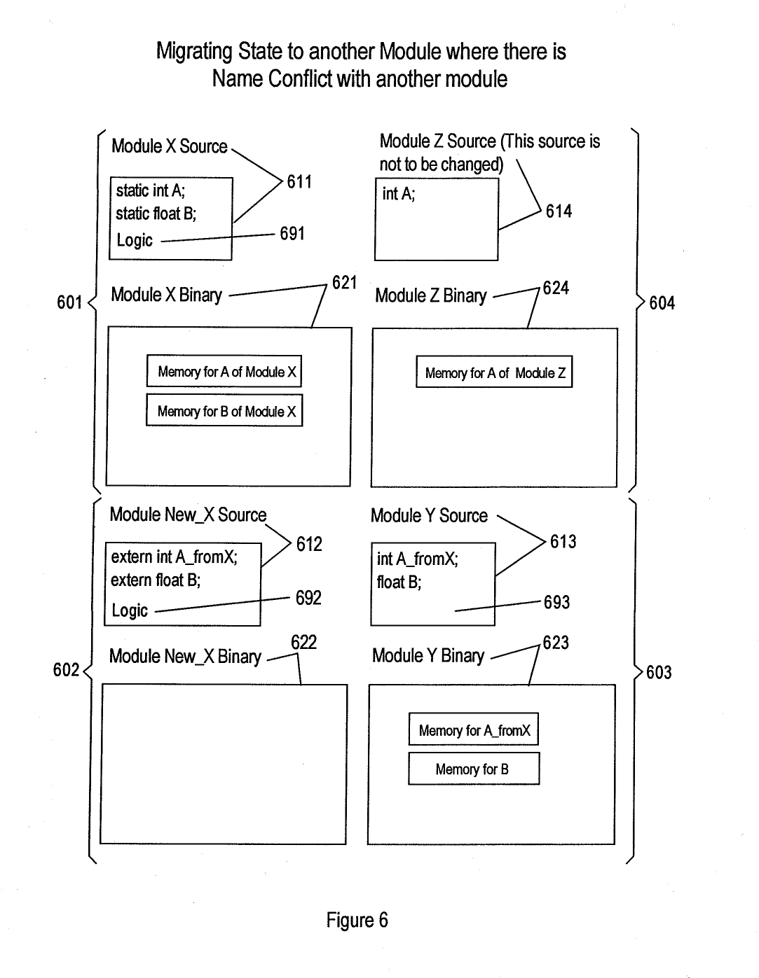

FIG. 6 is a diagram illustrating how the method in accordance with a still further embodiment converts an implementation module 601 into a replaceable implementation module 602 by using an interface module 603. This embodiment addresses the specific situation where there is name conflict with another module, e.g., 604. This situation requires not only redefinition of the global variables, but also renaming of the conflicting global variable(s).

Similar to implementation module 501, implementation module 601 can be presented as a Module X Source 611 or as a Module X Binary 621. When Module X Source 611 is complied by a complier (not shown), Module X Binary 621 will be outputted by the compiler, and can be subsequently linked and loaded in the memory of a computer system running implementation module 601.

Likewise, replaceable implementation module 602 can be presented as a Module New_X Source 612 or as a Module New_X Binary 622. When Module New_X Source 612 is complied by a complier (not shown), Module New_X Binary 622 will be outputted by the compiler, and can be linked and loaded in the memory of the computer system running replaceable implementation module 602.

Similarly, interface module 603 can be presented as a Module Y Source 613 or as a Module Y Binary 623. When Module Y Source 613 is complied by a complier (not shown), Module Y Binary 623 will be outputted by the compiler, and can be linked and loaded in the memory of the computer system running interface module 603.

Finally, “conflicting” module 604 can be presented as a Module Z Source 614 or as a Module Z Binary 624. When Module Z Source 614 is complied by a complier (not shown), Module Z Binary 624 will be outputted by the compiler, and can be linked and loaded in the memory of the computer system running module 604.

Module X Source 611 has global variables, such as A and B, which define the state information of implementation module 601. In this particular example, A and B are defined in implementation module 601 as static variables, meaning that A and B are stored at their fixed memory locations and/or private to the file in which they are defined. In the particular programming language of this embodiment, i.e., C or C++, “int A” (FIG. 5) and “static int A” (FIG. 6) are one and the same variable definition, meaning that A is a global variable, an integer, and is stored at a fixed memory location during the entire runtime of implementation module 601 (“static” is the default for global variables, i.e., variables defined outside any function or routine or subroutine or procedure or method or subprogram of logic 691, and also the default for private variables). The definition “static int” in FIG. 6 merely shows an alternative definition of global variables.

Similar to the process disclosed with reference to FIG. 5, implementation module 601 will be converted as follows. First, the declarations “static” in Module X Source 611 will be changed to “extern” to obtain Module New_X Source 612, because A and B should be defined external to Module New_X Source 612. Second, A and B will be globally defined in Module Y Source 613 using “int A” and “float B,” respectively. However, if A is globally defined in Module Y Source 613, there will be a name conflict between Module Y Source 613 and Module Z Source 614 which also defines A globally. This name conflict can be solved by additionally renaming the conflicting variable, i.e., A, as follows.

Specifically, the conflicting variable, i.e., A, is renamed in both interface module 603, i.e., Module Y Source 613, and replaceable implementation module 602, i.e., Module New_X Source 612, to avoid the name conflict with Module Z Source 614. For example, “A” is renamed to “A_fromX” as can be seen in FIG. 6 as 612 and 613. In addition, “A” should also be renamed to “A_fromX” throughout logic 692 which is substantially imported from logic 691 of Module X Source 611, in a manner similar to logic 592 described above with respect to FIG. 5.

This renaming can be done, like the above described redefinition, simply by using Find and Replace commands of a text editor. However, other means, either manual or automated, are not excluded.

The above description can be illustrated in the following example:

### EXAMPLE 2

Make all global static variables extern and resolve name conflicts.

Original implementation module 601 contains the following definitions and functions:

static int A;
static float B;
.....
A = r + s;
.....
X = A * Y;
.....

A tool, e.g., a compiler is used to identify whether there is any name conflict with A or B.
2A. If there is no name conflict with the same variable name in another module:

Implementation module 601 is modified as follows to create stateless or replaceable implementation module 602:

extern int A;
extern float B;
.....
A = r + s;
.....
X = A * Y;
.....

Variables A and B are added into interface module 603:
   int A;
   float B;
2B. If there is a name conflict with the same variable name, e.g., A, in another module, i.e., if the compiler tool shows that the variable name A is already used in another module, e.g., 604:
The conflicting variable name (at all occurrences) is changed to avoid the name conflict, e.g., “A” is renamed as “A_fromX” as follows:

In stateless or replaceable implementation module 602:

extern int A_fromX;
extern float B;
.....
A_fromX = r + s;
.....
X = A_fromX * Y;
.....

In interface module 603:
   int A_fromX;
   float B;

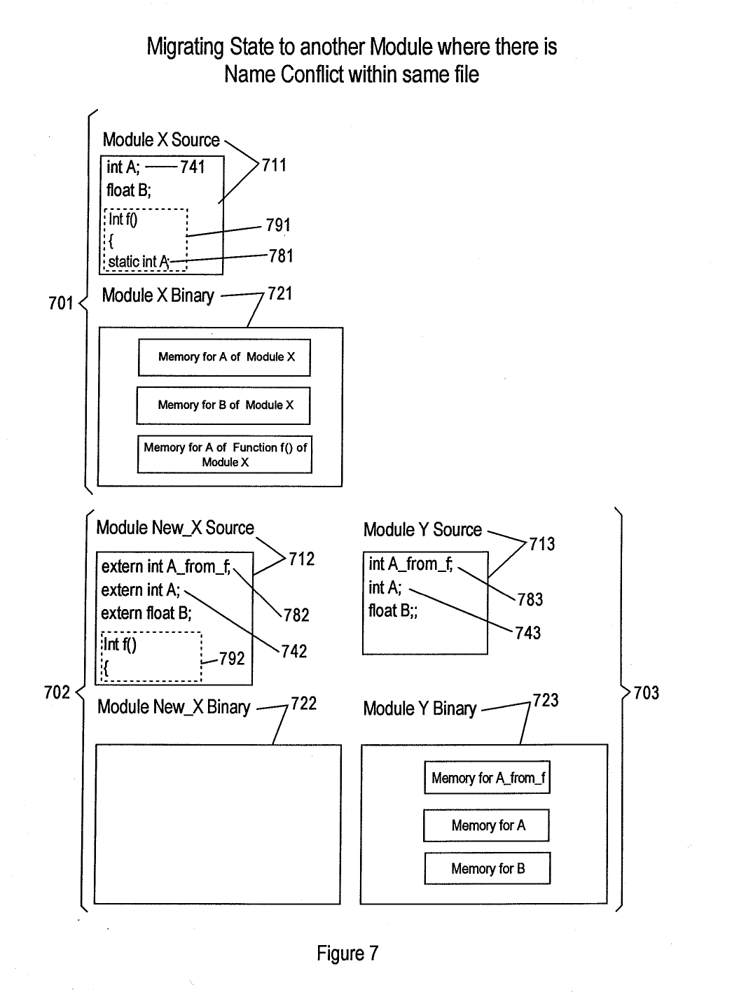

FIG. 7 is a diagram illustrating how the method in accordance with a still further embodiment converts an implementation module 701 into a replaceable implementation module 702 by using an interface module 703. This embodiment addresses the specific situation where there is name conflict within the same file. The embodiment also addresses the situation where local, static variables exist. Such local, static variables also define, together with globally defined variables, state information of the implementation module to be replaced, and therefore, should be moved to the interface module. This embodiment therefore requires redefinition of local, static variables as global variables. Then, like the embodiment disclosed with respect to FIG. 6, renaming of the conflicting global variable(s), if any, is required.

Similar to implementation module 501, implementation module 701 can be presented as a Module X Source 711 or as a Module X Binary 721. When Module X Source 711 is complied by a complier (not shown), Module X Binary 721 will be outputted by the compiler, and can be subsequently linked and loaded in the memory of a computer system running implementation module 701.

Likewise, replaceable implementation module 702 can be presented as a Module New_X Source 712 or as a Module New_X Binary 722. When Module New_X Source 712 is complied by a complier (not shown), Module New_X Binary 722 will be outputted by the compiler, and can be linked and loaded in the memory of the computer system running replaceable implementation module 702.

Similarly, interface module 703 can be presented as a Module Y Source 713 or as a Module Y Binary 723. When Module Y Source 713 is complied by a complier (not shown), Module Y Binary 723 will be outputted by the compiler, and can be linked and loaded in the memory of the computer system running interface module 703.

Module X Source 711 has global variables, such as A (designated at 741) and B, which define the state information of implementation module 701. Module X Source 711 further includes logic 791 similar to logic 791 described with respect to FIG. 7. Logic 791 may include one or more functions or routines or subroutines or procedures or methods or subprograms which have their own variable definitions one or more of which define(s), together with the global variables A and B, the state information of implementation module 701. In this very specific example, logic 791 includes function f( ) which locally declares another variable A, designated at 781, using the “static” definition, meaning that variable A 781 is visible only within function f( ) but maintains its value between calls to function f( ) at a fixed memory location. Such local, static variable should be moved to interface module 703 as well. This can be done as follows.

All local static variables of Module X Source 711 are made global, i.e., “static int A” 781 of Module X Source 711 is taken out of function f( ) and defined globally as “static int A” in a temporary version of Module New_X Source 712. This can be done by Find and Replace commands as described above.

The so-generated temporary Module New_X Source 712 is checked for name conflicts, e.g., by either Find command of a text editor program or by a complier. In this particular case, a name conflict exists between global variable A 741 of Module X Source 711 and local static variable A 781 of function f( ), because both variable A will appear as “extern int A” in Module New_X Source 712. A name change is thus required. In accordance with this particular embodiment, the local static variable A 781, that is to be made global in Module New_X Source 712, will be renamed, e.g., as “A_from_X” designated at 782, whereas the global variable A 741 retains its name. However, it is not excluded that the local static variable A 781 retains its name while the global variable A 741 is being renamed, or that both variables A are renamed.

Similarly, the corresponding definitions in Module Y Source 713 should be renamed as well. For example, the local static variable A 781 will be renamed as “A_from_X” designated at 783, whereas the global variable A 741 retains its name as shown at 743.

In addition, “A” should also be renamed to “A_from_X” throughout function f( ) in logic 792 which is substantially imported from logic 791 of Module X Source 711, in a manner similar to logic 692 described above with respect to FIG. 6.

Further renaming may be required if name conflicts exist between (i) the global variables of Module X Source 711 and local static variables of other functions or routines or subroutines or procedures or methods or subprograms within logic 791, or (ii) between local static variables of two or more of the functions or routines or subroutines or procedures or methods or subprograms within logic 791, or (iii) between the global and local static variables of Module X Source 711 and another implementation module, such as 604 shown in FIG. 6.

The above described renaming can be done, like the above described redefinition, simply by using Find and Replace commands of a text editor. However, other means are not excluded.

The global variables, e.g., A designated at 741 and B, and local-static-made-global variables, e.g., A_from_X, are globally declared as “extern” in Module New_X Source 712.

The above description can be illustrated in the following example:

### EXAMPLE 3

Handle local static variables and resolve name conflicts.

Original module 701 contains the following definitions and function:

int A;
float B;
...
f( )
{
static int Z;
static int A;
..........
B=A+Z;
}

a. All static variables within function f( ) are taken out of the function and made global as follows:

int A;
float B;
static int Z;
static int A;
...
f( )
{
..........
B=A+Z;
}

b. A tool, e.g., a compiler, is used to identify whether there is any name conflict with global variables A and B, and if there is one, the conflicting name is renamed:

int A;
float B;
static int Z;
static int A_from_f;
...
f( )
{
..........
B=A_from_f +Z;
}

c. The procedure described with respect to FIGS. 5 and 6 is performed to make all global variables “extern” as follows:

In stateless or replaceable implementation module 702:

extern int A;
extern float B;
extern int Z;
extern int A_from_f;
...
f( )
{
..........
B=A_from_f +Z;
}

In interface module 703

int A;
float B;
int Z;
int A_from_f;

d. The procedure described with respect to FIG. 6 is performed to determine whether there is any name conflict with other modules. If the compiler tool shows that a variable, e.g., A, has already been used, the variable name is changed (at all occurrences), e.g., to “A_fromX,” to avoid the name conflict, as follows:

In stateless or replaceable implementation module 702:

extern int A_fromX;
extern float B;
extern int Z;
extern int A_from_f;
...
f( )
{
..........
B=A_from_f +Z;
}

In interface module 703

int A_fromX;
float B;
int Z;
int A_from_f;

It can now be seen from the above description that an implementation module can be replaced or converted to a replaceable implementation module by simple code changes.

An exemplary conversion or replacement in accordance with the disclosed embodiments can be performed as follows. All the state information in the implementation module is transferred to an interface module by adding ‘extern’ definitions. The applications are linked to the interface module. The interface module contains dummy functions that call the actual functions in the implementation module. When the implementation module on the disk is to be replaced with a new module, all the applications using the module are notified by sending a signal. The signal handler in the interface module gets invoked and it sets a flag to indicate that the implementation module should be replaced. The interface module starts blocking all new calls to the implementation module. When all ongoing calls in the implementation module return, the interface module unloads the implementation module and loads the new module. The interface module resolves all function pointers in the newly loaded module and may call a constructor in the newly loaded module. Finally, it resets the flag and allows the blocked calls to continue to the new module.

The disclosed embodiments satisfy one or more of the following constraints.

Constraint A. Generic OLRM (Online replacement of modules) implementation requires that functions of the module being replaced should “not” be “in use” while OLRM is happening. We define a function as “in use” if any call made to this function has not returned. Stack variables and address of a function in the new module could be different from the same function in the old (replaced) module. If a function of a module being replaced is “in use”, the existing stack image could potentially lead to invalid behavior after the new module is loaded. Hence, old stack could be incompatible with the new module. Not satisfying this constraint may severely limit changes that can be made in the new module.

Constraint B. To continue operation of the application/system after replacement of a module, the online replaceable module should not contain permanent state information. However, they may/can contain temporary state information. Temporary state information is defined here as state information that will cease to exist when none of the functions of the module is “in use”. All of the state information that is not temporary is defined as permanent state information. Developing online replaceable modules without satisfying this constraint will require support to retain or methods to save/restore permanent state information; both these alternatives are highly error prone.

Constraint C. If a new version of the module has additional permanent state information, new variables corresponding to the additional state information should be added to the heap storage. Not satisfying this constraint will add same limitations as Constraint B.

Constraint D. If a new version of the module operates on different data structure definitions with respect to older versions, newer data structures should be created on the heap, and state information should be copied from the old data structure to new data structures.

Constraint E. It is recommended that as much as possible the code changes required for making a module online replaceable should not be placed within the replaceable module itself. All the code for checking Constraint A and resolving symbols of newly loaded module should be kept outside the module itself. This approach simplifies the changes required for adding online replacement functionality to existing modules. While this is not a strict requirement, with this constraint, porting is limited to just redefinition of data structures for well-behaved modules. A module is considered well behaved if the module can satisfy Constraint A within a finite time without additional code changes.

If the application is multi-threaded and if the threads call functions from the module being replaced, the threads will block until replacement is complete. If the application is written in such a way that not all of its threads access functions of modules that can be replaced, remaining threads will continue to run even during module replacement. In this way application continuity is ensured even while modules of the application are being replaced.

Similarly when an Operating System (kernel) module is replaced, only threads that call the module will block and the system can continue to be available even during OS module replacement.

Current technologies do not provide application/system availability during module replacements. The advantage of one or more of the disclosed embodiments of the present invention is that it provides contiguous application/system availability even when a component module of the application/system is replaced. For example, an Airline Reservation system could be enhanced to add security features while bookings are ongoing. With the present invention, users of the application may only see small additional delay while replacement is happening, but no disruption.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A method of replacing an implementation module used by a system, comprising:
i) creating an interface module;
ii) creating a plurality of proxy functions within the interface module corresponding to a plurality of functions within the implementation module;
iii) tracking entries into and exits out of the implementation module by the system;
iv) when the implementation module is to be replaced:
a. the interface module blocking entry by the system into the implementation module; and
b. when the number of entries correspond to the number of exits, replacing the implementation module;
wherein the system uses the functions within the implementation module by calling the proxy functions and wherein global and static variables of the implementation module are defined within the interface module.

2. A method as claimed in claim 1, wherein all global and static variables the implementation module are defined in the interface module rather than in the implementation module.

3. A method as claimed in claim 1, wherein the interface module blocks entry by the system into the implementation module only when it is safe to do so.

4. A method as claimed in claim 1, wherein the interface module performs step (iii).

5. A method as claimed in claim 1, wherein the tracking is performed using at least one of a reference counter and reference flags.

6. A method as claimed in claim 1, wherein the implementation module is replaced with one of an updated version and a corrected version.

7. A method as claimed in claim 1, wherein each proxy function has the calling name of the corresponding function and the corresponding function is renamed.

8. A method of converting an implementation module, comprised of a plurality of functions, to a replaceable implementation module, comprising the steps of:
i) creating an interface module;
ii) creating a plurality of proxy functions, corresponding to the implementation functions, within the interface module; and
iii) defining global and static variables of the implementation module in the interface module rather than in the implementation module.

9. A method as claimed in claim 8, further comprising renaming the calling names of the implementation functions.

10. A method as claimed in claim 8, further comprising defining all global and static variables of the implementation module as external to said implementation module.

11. A method as claimed in claim 8 wherein the interface module is arranged for tracking the number of implementation functions in use, blocking calls to use the implementation functions when the implementation module is to be replaced, and replacing the implementation module when no implementation functions are in use.

12. An interface module for an implementation module, comprising:
i) a plurality of proxy functions corresponding to a plurality of functions within the implementation module;
ii) a tracking mechanism for recording the number of implementation functions in use;
iii) a blocking mechanism for blocking calls to the implementation functions when the module is to be replaced;
iv) a replacement mechanism for replacing the implementation module when no functions are in use; and
v) all global and static variables extracted from the implementation module.

13. A system for replacing an implementation module, comprising:
i) a memory which stores an implementation module comprised of a plurality of functions;
ii) a memory which stores an interface module comprised of all static and global variables extracted from the implementation module and a plurality of proxy functions corresponding to the implementation functions; and
iii) a processor arranged for (a) relaying calls to use an implementation function to a corresponding proxy function, (b) tracking the use of the implementation functions, (c) blocking calls to the implementation functions when the implementation module is to be replaced, and (d) replacing the implementation module when no implementation functions are in use.

14. A storage medium storing therein a program which, when executed by a computer, causes said computer to perform the method of claim 1.

15. A storage medium storing therein a program which, when executed by a computer, causes said computer to perform the method of claim 8.

16. A binary file comprising an interface module and a replaceable implementation module created according to the method of claim 8.

17. A binary file comprising an interface module as claimed in claim 12.

18. A method comprising the step of supplying a computer with a program for causing, when executed by the computer, the computer to perform the method of claim 1.

19. A method comprising the step of supplying a computer with a program for causing, when executed by the computer, the computer to perform the method of claim 8.
